(19) United States
(12) Patent Application Publication
(10) Pub. No.: US 2011/0008600 A1
(43) Pub. Date: Jan. 13, 2011

(54) CHEMICAL BARRIER LAMINATION AND METHOD

(76) Inventor: Edward D. Walsh, East Greenwich, RI (US)

Correspondence Address: MCCARTER & ENGLISH, LLP HARTFORD;CITYPLACE I, 185 ASYLUM STREET, HARTFORD, CT, 06103, US

(21) Appl. No.: 12/649,183

(22) Filed: Dec. 29, 2009

Related U.S. Application Data
(60) Provisional application No. 61/141,199, filed on Dec. 29, 2008.

(51) Int. Cl. A62D 5/00; B32B 7/02; B32B 27/28; B32B 37/14; B32B 38/00; B32B 38/10; B32B 37/24

(52) U.S. Cl. 428/216; 428/421; 428/422; 428/35.2; 428/36.91; 156/60; 216/34; 156/256; 156/244.18

(57) ABSTRACT

A chemical barrier lamination has a first fluoropolymer layer, and a second fluoropolymer layer laminated to the first fluoropolymer layer and forming a non-porous, chemically inert, moisture vapor transmission barrier lamination. A method for making a chemical barrier lamination is also shown and described.

### CROSS-REFERENCE TO PRIORITY APPLICATION

This patent application claims priority under 35 U.S.C. §119 to U.S. provisional patent application Ser. No. 61/141,199, filed Dec. 29, 2008, entitled “Chemical Barrier Lamination and Method”, which is hereby expressly incorporated by reference in its entirety as part of the present disclosure.

### FIELD OF THE INVENTION

The present invention relates to multilayered laminates, sheets and films, and methods of making the same. More particularly, the present invention relates to chemical barrier laminations including at least two layers of fluoropolymers, and a method of making the same.

### BACKGROUND OF THE INVENTION

Fluoropolymer materials are well known for having desirable material properties, such as excellent moisture and vapor barrier characteristics, as well as chemical inertness, including resistance to acids, bases and solvents and stability in most chemical environments. Fluoropolymers are also well known for their resistance to high temperatures, and for having a low coefficient of friction.

Fluoropolymers, including fluorinated ethylene propylene (FEP), polytetrafluoroethylene (PTFE) and expanded polytetrafluoroethylene (ePTFE), are desirable in a number of industrial applications. For example, fluoropolymers are desirable for use in chemical, medical and pharmaceutical applications, as well as a variety of containment and packaging applications. Fluoropolymers are also desirable for use in a variety of electrical and optical applications.

Individual fluoropolymer layers are known to be manufactured in a number of ways, including casting, extruding and skiving. Skiving is traditionally the most cost effective method of forming individual layers, as film is created by shaving or cutting layers off of a bulk mass of material. One common method of skiving is accomplished by placing a blade or cutting implement in contact with a cylindrical stock and removing a layer by rotating the cylindrical stock. However, one drawback associated with fluoropolymer layers skived from a bulk mass of fluoropolymer material is that small apertures are often found throughout the layer. Air bubbles are commonly introduced into the material during the formation of the bulk material and, when the bulk material is skived into thin layers, these air bubbles form apertures in the skived film, which are undesirable and may reduce the excellent properties of the material. Typically these apertures are small and of the nature of a pinhole.

Various attempts have been made to produce multilayered films including fluoropolymers. It is well known in the art to create multilayered films which join fluoropolymer materials to non-fluoropolymer materials. One such example is the joining of a fluoropolymer film to a non-fluoropolymer film by the use of an adhesive or a tie layer.

It is also known in the art to create fluoropolymer sheets by casting the fluoropolymers in sheet form. However, there are a number of drawbacks associated with this process, including the undesirably low density resulting in the cast film, and the costliness of the casting process and casting machinery.

Accordingly, it is an object of the present invention to overcome one or more of the above-described drawbacks and disadvantages of the prior art.

### SUMMARY OF THE INVENTION

In accordance with a first aspect, the present invention is directed to a chemical barrier lamination comprising a first substantially solid fluoropolymer layer, and a second substantially solid fluoropolymer layer laminated to the first substantially solid fluoropolymer layer and forming a non-porous, chemically inert moisture vapor transmission barrier lamination.

In some embodiments of the present invention, the first layer is a skived fluoropolymer film. In some such embodiments, each of the first and second layers is a skived fluoropolymer film. In some such embodiments, the first and second skived fluoropolymer films are laminated directly to each other. In some embodiments, the fluoropolymer of the skived fluoropolymer film is FEP, tetrafluoroethylene/hexafluoropropylene/vinylidene fluoride (THV), perfluoroalkoxy copolymer resin (PFA), PTFE, polyvinylidene fluoride (PVDF), ePTFE and/or combinations (or blends) of one or more of the foregoing.

Some embodiments of the present invention comprise at least one skived fluoropolymer film layer, and at least one non-skived fluoropolymer film layer laminated to the at least one skived fluoropolymer film layer. In some such embodiments, the at least one non-skived fluoropolymer is a melt extruded fluoropolymer film laminated directly to the skived fluoropolymer film. In some embodiments, the fluoropolymer of the non-skived fluoropolymer film is FEP, THV, PFA, PTFE, PVDF, ePTFE and/or combinations (or blends) of one or more of the foregoing. In some embodiments of the present invention, the at least one non-skived fluoropolymer film layer includes at least two second layers of melt extruded fluoropolymer. In some such embodiments, one of the melt extruded fluoropolymer films is filled to alter color and/or static dissipativity, and another melt extruded fluoropolymer film is unfilled for chemical inertness. In some embodiments of the present invention, the skived fluoropolymer film layer is made of PTFE and defines a thickness within the range of about ½ mil to about 4 mils, and the non-skived fluoropolymer film layer defines a thickness within the range of about ½ mil to about 4 mils. Some embodiments of the present invention further comprise at least one layer of skived PTFE, and at least two layers of extruded FEP laminated to the at least one layer of skived PTFE. The skived PTFE includes without limitation modified and homopolymer materials. The modified materials include small amounts of modifiers in the resins, such as PFA, to improve barrier properties. In some such embodiments, one of the FEP layers is an inner layer that is filled for color, and another FEP layer is an outer layer that is non-filled for chemical inertness.

Some embodiments of the present invention further comprise at least one non-fluoropolymer layer laminated to the first and second layers. In one such embodiment, the non-fluoropolymer layer is a polyethylene layer laminated between first and second fluoropolymer layers.

In accordance with another aspect, the present invention is directed to a chemical barrier lamination comprising first means formed of a substantially solid fluoropolymer and defining a thickness within the range of about ½ mil to about 4 mils for providing a chemically inert moisture vapor transmission barrier. The lamination further includes second means laminated to the first means, formed of a substantially solid fluoropolymer, and defining a thickness within the range of about ½ mil to about 4 mils, for providing a chemically inert moisture vapor transmission barrier.

In some embodiments of the present invention, the first means is a first substantially solid fluoropolymer layer, and the second means is a second substantially solid fluoropolymer layer laminated to the first substantially solid fluoropolymer layer. In some such embodiments, each substantially solid fluoropolymer layer is a skived fluoropolymer layer, a non-skived fluoropolymer layer, a melt extruded fluoropolymer layer, FEP, THV, PFA, PTFE, PVDF, ePTFE, and/or combinations (or blends) of one or more of the foregoing.

Some embodiments of the present invention further comprise third means laminated between the first and second means for substantially preventing the transmission of gas therebetween. In some such embodiments, the third means is a polyethylene film.

In accordance with another aspect, the present invention is directed to a method comprising the following steps:

(i) providing a first substantially solid fluoropolymer layer;

(ii) providing a second substantially solid fluoropolymer layer; and

(iii) laminating the first and second substantially solid fluoropolymer layers into a non-porous, chemically inert, moisture vapor transmission barrier lamination.

In some embodiments of the present invention, the laminating step includes applying heat and/or pressure to the first and second layers. In some such embodiments, the laminating step further includes subjecting the layers to a temperature within the range of about 600° F. to about 800° F. In some such embodiments, the temperature is within the range of about 675° F. to about 725° F. In some embodiments of the present invention, the laminating step includes (i) calendaring the first and second layers; and/or (ii) autoclaving the first and second layers.

Some embodiments of the present invention further comprise modifying at least one of the first and second layers to enhance bondability during lamination. In some such embodiments, the modifying step includes (i) chemically etching at least one of the first and second layers to facilitate bonding thereof during lamination, and/or (ii) at least one of plasma treating and corona treating at least one of the first and second layers to facilitate bonding thereof during lamination.

In some embodiments of the present invention, the providing step includes skiving a fluoropolymer into a skived film forming at least one of the first and second substantially solid fluoropolymer layers. In some such embodiments, the providing step includes skiving first and second fluoropolymer films, and the laminating step includes laminating the first and second skived films directly to each other.

In other embodiments of the present invention, the providing step includes skiving at least one fluoropolymer film and providing at least one melt extruded fluoropolymer film, and the laminating step includes laminating the at least one skived fluoropolymer film to the at least one melt extruded fluoropolymer film.

One advantage of the present invention is that the chemical barrier lamination is substantially aperture-free and may be formed with one or more relatively inexpensive skived fluoropolymer layers.

Another advantage of the present invention is that the chemical barrier lamination may be chemically inert and therefore is useful in a variety of chemical and medical applications.

Another advantage of the present invention is that the chemical barrier lamination can provide an excellent barrier to moisture vapor transmission and therefore is useful in a variety of packaging applications.

Yet another advantage of some currently preferred embodiments of the present invention is that two skived fluoropolymer layers may be laminated directly to each other to, in turn, provide a non-porous, chemically inert moisture vapor transmission barrier lamination that is more cost effective than prior art fluoropolymer laminations and provides a better moisture vapor transmission barrier than such prior art fluoropolymer laminations.

A still further advantage of some currently preferred embodiments of the present invention is that one or more skived fluoropolymer layers may be laminated to one or more non-skived fluoropolymer layers, such as a melt extruded fluoropolymer layer, such that the skived fluoropolymer layer(s) provide a cost-effective moisture vapor transmission barrier and the non-skived layer(s) provide color, chemical inertness, and/or a desired texture or aesthetic appearance (e.g., a high sheen).

Other advantages of the present invention and/or of the currently preferred embodiments thereof will become more readily apparent in view of the following detailed description and accompanying drawings.

### BRIEF DESCRIPTION OF THE DRAWINGS

FIG. 1A is a side elevational view of a first embodiment of a chemical barrier lamination of the present invention including first and second fluoropolymer layers.

FIG. 1B is a side elevational view of another embodiment of a chemical barrier lamination of the present invention including first and second fluoropolymer layers and an intervening non-fluoropolymer layer.

FIG. 1C is a side elevational view of another embodiment of a chemical barrier lamination of the present invention including first, second and third fluoropolymer layers.

FIG. 1D is a side elevational view of another embodiment of a chemical barrier lamination of the present invention including plural first and second layers.

FIG. 2A is a perspective view of another embodiment of a chemical barrier lamination of the present invention forming a bag.

FIG. 2B is a perspective view of another embodiment of a chemical barrier lamination of the present invention forming at least part of a container closure.

FIG. 2C is a perspective view of another embodiment of a chemical barrier lamination of the present invention forming at least part of a septum.

FIG. 2D is a perspective view of another embodiment of a chemical barrier lamination of the present invention forming at least part of a tube.

FIG. 3 is a side elevational view of an apparatus for forming a chemical barrier lamination through the application of heat and pressure in accordance with the present invention.

### DETAILED DESCRIPTION OF THE CURRENTLY PREFERRED EMBODIMENTS

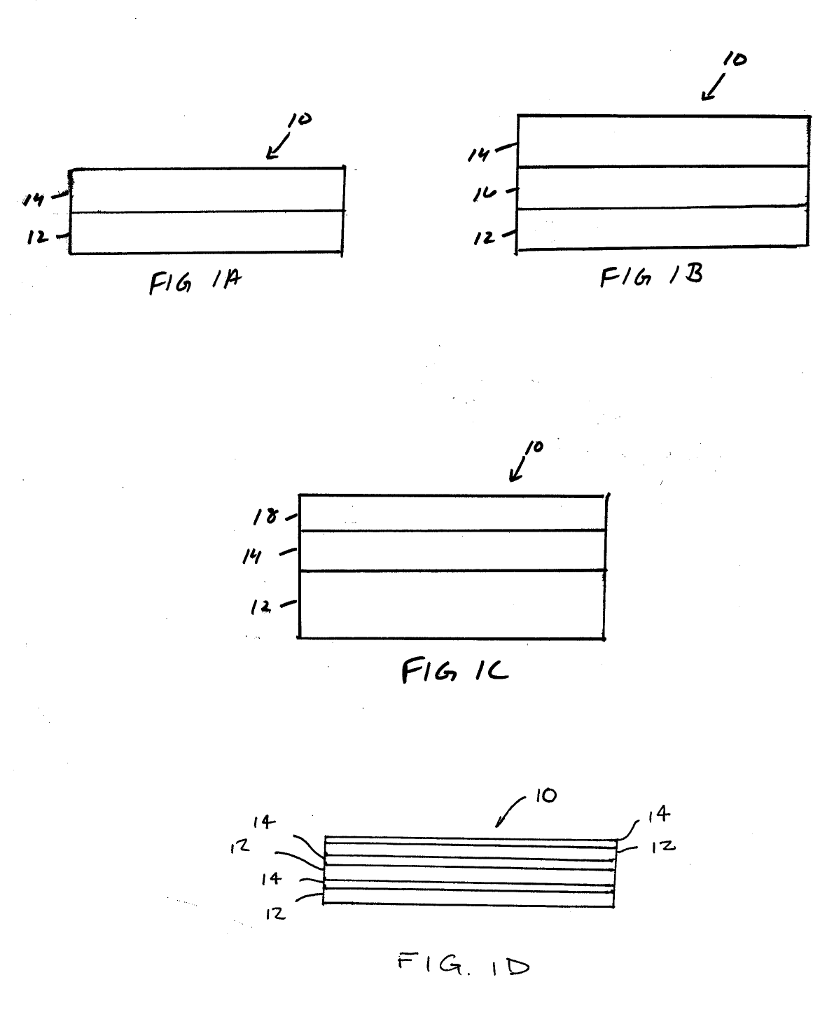

Referring to the drawings and, in particular, FIG. 1A, a chemical barrier lamination in accordance with an illustrative embodiment of the present invention is indicated generally by the reference numeral 10. The lamination 10 comprises a first fluoropolymer layer 12, and a second fluoropolymer layer 14 laminated to the first fluoropolymer layer 12. As described further below, the layers 12 and 14 may be formed of any of a variety of fluoropolymers, or combinations thereof. In addition, although the laminations of the present invention may consist of only fluoropolymer layers, the laminations may include layers of other materials, such as one or more polymeric layers, including, for example, a polyethylene layer.

The fluoropolymers used to form the layers of the lamination 10 may include without limitation FEP, THV, PFA, PTFE, PVDF, ePTFE and/or combinations (or blends) of one or more of the foregoing. In addition, the layers of the lamination may be formed in any of numerous different ways that are currently known, or that later become known, including skiving or extruding. Accordingly, the layers 12 and 14 may be formed of any fluoropolymer that is currently known or that later becomes known to those of ordinary skill in the pertinent art, and may be formed in accordance with any of numerous different manufacturing processes that are currently known, or that later become known to those of ordinary skill in the pertinent art.

Although the fluoropolymer layers 12 and 14 are substantially solid, they may include undesirable apertures or pin holes. For example, such apertures may be the result of manufacturing processes, such as skiving fluoropolymer materials into thin layers. Typically, bulk fluoropolymer material contains air bubbles. When the material is skived into thin layers, the air bubbles form tiny apertures in those layers. Such apertures also may result from other treatments or processes used to form the fluoropolymer in bulk, film or other form.

The lamination of the fluoropolymer layers 12 and 14 together produces a non-porous or substantially aperture-free laminated film 10. In the embodiments in which one or more of the layers 12, 14 are skived, the lamination seals the pinholes formed in each skived layer and thereby forms a solid, non-porous moisture vapor transmission barrier. The resulting lamination 10 may exhibit one or more of the following characteristics: the lamination may form a moisture vapor transmission barrier, be chemically inert, be resistant to acids, bases and solvents, maintain stability in most chemical environments, have a resistance to high temperatures, and/or have a low coefficient of friction. The lamination 10 may be flexible or rigid.

Each of the layers 12, 14 preferably defines a thickness within the range of about ½ mil to about 4 mils, and the lamination 10 preferably defines an overall thickness within the range of about 1 mil to about 10 mils. As shown in FIG. 1B, the lamination 10 also may include a non-fluoropolymer layer, such as an intervening polyethylene layer 16.

Referring to FIG. 1C, the lamination 10 comprises a first layer 12 and at least two second layers 14 and 18. Each of the layers 12, 14 and 18 may be formed from any of a variety of fluoropolymer materials, including FEP, THV, PTFE, ePTFE, and combinations or blends of the foregoing, and may be formed in any of numerous different ways that are currently known, or that later become known, including skiving or extruding. The lamination of FIG. 1C likewise may include one or more non-fluoropolymer layers, such as one or more intervening polyethylene layers.

Referring to FIGS. 1A-1C, each of the layers 12, 14, 16 and 18 may be a modified film; for example, one of the layers may include a modifier to enhance bondability, to seal the layer, or to alter any of the physical or chemical properties of the layer, such as chemical resistance, temperature resistance, electric conductivity, strength, or coefficient of friction. One example of a such modifier is PFA.

One or both of the second layers 14 and 18 may be filled. For example, one of the two layers may be filled with a color, while the other, preferably an outer layer, remains unfilled for chemical inertness, or one of the two layers may be filled with carbon to alter the static dissipative properties of the layer. One of the two layers may be filled with any chemical that is currently known or that later becomes known to those of ordinary skill in the pertinent art to alter the physical or chemical properties of that layer.

In another embodiment of the present invention, the chemical barrier lamination of FIG. 1B includes a first layer 12 of PTFE, a second layer 14 of ePTFE, and a third layer 16 laminated between the second and third layers that is FEP, THV, PFA, PVDF and/or combinations or blends of one or more of the foregoing. In this embodiment, the first and second layers 12 and 14, respectively, are skived and the third layer 16 is a melt. One advantage of this embodiment is that the outer or second layer of ePTFE allows the lamination to be sealed into bags or like articles.

In another embodiment of the present invention, the chemical barrier lamination of FIG. 1A includes a first layer 12 of ePTFE and a second layer 14 that is FEP, THV, PFA, PVDF and/or combinations or blends of one or more of the foregoing. This particular embodiment is particularly suitable for forming hoses, wire or cable insulation, bags, tubes and like structures or articles. The layers are wrapped (e.g., wrapped around the wire or cable if forming insulation, or wrapped around a mandrel or like structure if forming a tube) and heated in a manner known to those of ordinary skill in the pertinent art to form the resulting structure. The ePTFE facilitates in holding the layered materials together during the heating process. If desired, this chemical barrier lamination can be provided in roll stock form for wrapping (e.g., in spiral form) wire or hose.

In another embodiment of the present invention, the chemical barrier lamination of FIG. 1D includes a plurality of first layers 12 and a plurality of second layers 14, wherein each first layer 12 is laminated to at least one respective second layer 14. Each first layer 12 is PTFE, and each second layer 14 is FEP, THV, PFA, PVDF and/or combinations or blends of one or more of the foregoing. In the illustrated embodiment, each first layer 12 is skived and each second layer 14 is non-skived. Each first layer 12 preferably defines a thickness within the range of about 1 mil to about 5 mils, and more preferably defines a thickness within the range of about 3 mils to about 4 mils. Each second layer 14 defines a thickness within the range of about ½ mil to about 4 mils, and more preferably defines a thickness within the range of about ½ mil to about 2 mils. In some such embodiments, one or more of the first layers 12 are pigmented for color and one or more of the second layers 14 are clear. One advantage of this configuration is that it can be used to form a build up of layers to make, for example, a diaphragm or other multiple layer structures or articles. The ePTFE facilitates in holding the layered materials together during the heating process. The lamination can be heated in sheet or in roll (or wrapped) form. Although the embodiment of FIG. 1D includes three of each of the first and second layers 12 and 14, respectively, the laminations can include any desired number of layers, including without limitation more than three of each layer or few than three of each layer, more of one layer than the other, and if desired, additional different layers.

In another embodiment of the present invention, the chemical barrier lamination of FIG. 1A includes a first layer 12 that is FEP, THV and/or combinations or blends of the foregoing, and a second layer 14 that is polyethylene, polyethylene naphthalate (PEN), nylon and/or combinations or blends of the foregoing. In another such embodiment, the first layer 12 is PTFE, PFA, FEP, THV, PVDF, and/or combinations or blends of the foregoing. In another embodiment of the present invention, the chemical barrier lamination of FIG. 1 includes a first layer 12 that is FEP and a second layer 14 that is PEN. This particular lamination is particularly suitable as a barrier film. In these embodiments of FIG. 1, the first layer 12 preferably defines a thickness within the range of about ½ mil to about 5 mils, and more preferably defines a thickness within the range of about 2 mils to about 3 mils; and the second layer 14 preferably defines a thickness within the range of about ½ mil to about 3 mils, and more preferably defines a thickness within the range of about ½ mil to about 1 mil.

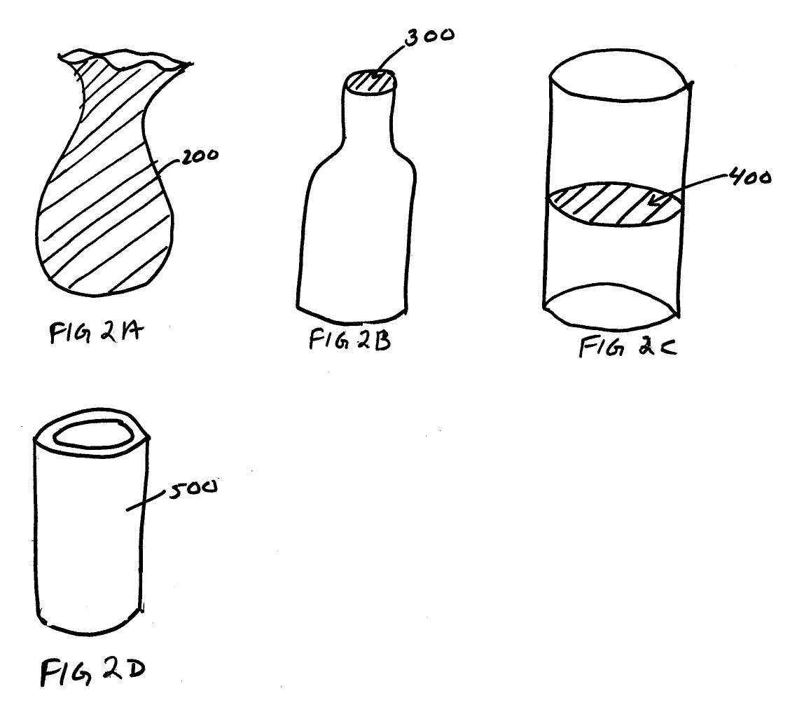

Turning to FIGS. 2A-2D, the laminations of the present invention can be used to form at least part of a bag 200 (FIG. 2A), a container closure 300 (FIG. 2B), a septum 400 (FIG. 2C) and a tube 500 (FIG. 2D). As may be recognized by those of ordinary skill in the pertinent art based on the teachings herein, the laminated films of the present invention may form at least part of any closure, bag, tube or septum that is currently known, or that later becomes known. In each of these embodiments, and in particular, the embodiments defining a container closure and a septum (e.g., a needle penetrable stopper), the fluoropolymer layers are laminated to a base layer or structure formed of rubber and/or a thermoplastic. The rubber and/or thermoplastic base may be provided to effect a fluid-tight seal, or to allow needle penetration, whereas the fluoropolymer lamination may be provided for chemical inertness and a moisture vapor transmission barrier. Typically, the fluoropolymer lamination will face the product sealed within the container or device, although other variations are contemplated. As may be recognized by those of ordinary skill in the pertinent art based on the teachings herein, the fluoropolymer laminations of the present invention may be laminated to any of numerous other substrates, structures or laminations to form any of numerous different articles or devices and/or to achieve any of numerous different characteristics.

The laminated films of FIGS. 1-2D are made in accordance with a method comprising the following steps:
(i) providing a first fluoropolymer layer 12;
(ii) providing a second fluoropolymer layer 14 (or other layers, such as the layers 16, 18, or the multiple first and second layers 12, 14, as described above); and
(iii) laminating the plural layers into a non-porous, chemically inert moisture vapor transmission barrier lamination 10.

In one currently preferred embodiment, the first layer is skived and the second layer is not skived. In one such embodiment, the first layer is a skived PTFE, and the second layer is a melt extruded fluoropolymer. In one such embodiment, the melt extruded fluoropolymer is FEP. In another embodiment, both the first and second layers are skived. In one such embodiment, the first layer is skived FEP, THV, PFA, PTFE, PVDF, ePTFE and/or combinations (or blends) of one or more of the foregoing, and the second layer is skived FEP, THV, PFA, PTFE, PVDF, ePTFE and/or combinations (or blends) of one or more of the foregoing.

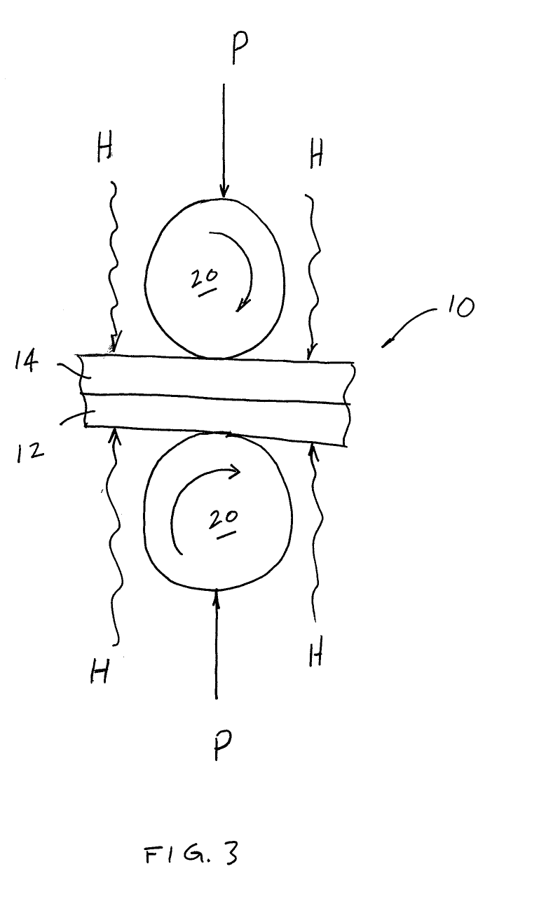

Referring again to FIG. 3, the method further comprises applying at least one of heat “H” and pressure “P” to the plurality of layers, such as the first layer 12 and second layer 14. In the illustrated embodiment, the temperature during the heating step is about 700° F. Preferably, the temperature is within the range of about 600° F. to about 800° F., and more preferably, is within the range of about 675° F. to about 725° F. As may be recognized by those of ordinary skill in the pertinent art based on the teachings herein, these ranges are only exemplary, and numerous other temperatures or temperature ranges, and any of numerous pressures, pressure ranges, and time periods for subjecting the laminations to such temperatures and/or temperature ranges, equally may be employed. Furthermore, the heat necessary to bond the layers may be applied through any of numerous different means that are currently known, or that later become known to those of ordinary skill in the pertinent art. As indicated in FIG. 3, the requisite pressure “P” necessary to bond the layers at the applied temperature may be achieved through calendaring rolls 20 in a manner known to those of ordinary skill in the pertinent art. As indicated by the arrows “H” in FIG. 3, heat may be applied during calendaring to subject the lamination to a sufficiently high temperature to bond the layers under the applied pressure “P”, such as the temperatures and/or temperature ranges described above. Alternatively, the pressure “P” may be applied by autoclaving, or by any of numerous other mechanisms or processes for applying the requisite pressure for lamination that are currently known, or that later become known.

In some embodiments of the present invention, the method further includes chemical etching the surface of at least one of the first and second layers. The chemical etching step may include the application of sodium ammonia, sodium napthalene and/or any other chemical etching process that is currently known, or that later becomes known to those of ordinary skill in the pertinent art to enhance the bondability of the layers.

The surfaces of the fluoropolymer layers also may be modified to enhance bondability by subjecting them to a plasma treatment and/or a corona treatment in a manner known to those of ordinary skill in the pertinent art. For example, the plasma treatment may take place in a nitrous environment. The corona treatment, on the other hand, may take place in a standard atmosphere. As may be recognized by those of ordinary skill in the pertinent art based on the teachings herein, numerous other treatments for modifying the fluoropolymer layers to enhance bondability that are currently known, or that later become known, equally may be employed.

As may be recognized by those of ordinary skill in the pertinent art based on the teachings herein, numerous changes and modifications may be made to the above-described and other embodiments of the present invention without departing from its scope as defined in the appended claims. For example, the lamination can include any desired number of layers to define any of numerous different physical and/or chemical characteristics; the layers may be laminated in accordance with any of numerous different methods and/or apparatus for laminating that are currently known, or that later become known; the fluoropolymer layers of the lamination may take the form of any of numerous different fluoropolymers that are currently known, or that later become known; the layers may be modified to enhance bondability to each other in accordance with any of numerous different processes or treatments that are currently known, or that later become known; and the fluoropolymer layers may be laminated or otherwise bonded to any of numerous other substrates, other laminations, or other structures, to form any of numerous different articles or devices. Accordingly, this detailed description of the currently preferred embodiments is to be taken in an illustrative as opposed to a limiting sense.

What is claimed is:

1. A chemical barrier lamination comprising:
a first substantially solid fluoropolymer layer; and
a second substantially solid fluoropolymer layer laminated to the first substantially solid fluoropolymer layer and forming a non-porous, chemically inert moisture vapor transmission barrier lamination.

2. A chemical barrier lamination as defined in claim 1, wherein the first layer is a skived fluoropolymer film.

3. A chemical barrier lamination as defined in claim 2, wherein each of the first and second layers is a skived fluoropolymer film.

4. A chemical barrier lamination as defined in claim 3, wherein the first and second skived fluoropolymer films are laminated directly to each other.

5. A chemical barrier lamination as defined in claim 3, wherein the fluoropolymer of the skived fluoropolymer film is at least one of FEP, THV, PFA, PTFE, PVDF, ePTFE and combinations or blends of one or more of the foregoing.

6. A chemical barrier lamination as defined in claim 1, further comprising at least one skived fluoropolymer film layer, and at least one non-skived fluoropolymer film layer laminated to the at least one skived fluoropolymer film layer.

7. A chemical barrier lamination as defined in claim 6, wherein the at least one non-skived fluoropolymer is a melt extruded fluoropolymer film laminated directly to the skived fluoropolymer film.

8. A chemical barrier lamination as defined in claim 6, wherein the fluoropolymer of the non-skived fluoropolymer film is at least one of FEP, THV, PFA, PTFE, PVDF, ePTFE and combinations or blends of one or more of the foregoing.

9. A chemical barrier lamination as defined in claim 6, wherein the at least one non-skived fluoropolymer film layer includes at least two second layers of melt extruded fluoropolymer.

10. A chemical barrier lamination as defined in claim 6, wherein at least one skived fluoropolymer film layer is filled to alter at least one of the color and static dissipativity thereof, and at least one non-skived fluoropolymer film layer is a melt extruded fluoropolymer film that is unfilled for chemical inertness.

11. A chemical barrier lamination as defined in claim 1, further comprising at least one polyethylene layer laminated to at least one of the first layer and the second layer.

12. A chemical barrier lamination as defined in claim 6, wherein the skived fluoropolymer film layer is made of PTFE and defines a thickness within the range of about ½ mil to about 4 mils, and the non-skived fluoropolymer film layer defines a thickness within the range of about ½ mil to about 4 mils.

13. A chemical barrier lamination as defined in claim 6, further comprising at least one layer of skived PTFE, and at least two layers of extruded FEP laminated to the at least one layer of skived PTFE, wherein one of the FEP layers is an inner layer that is filled for color, and another FEP layer is an outer layer that is non-filled for chemical inertness.

14. A chemical barrier lamination as defined in claim 13, wherein each FEP layer defines a thickness within the range of about ½ mil to about 3 mils.

15. A chemical barrier lamination as defined in claim 13, further comprising at least one of a rubber and a thermoplastic layer laminated to the first and second layers and forming at least one of a septum and a container closure.

16. A chemical barrier lamination as defined in claim 1, wherein the lamination forms at least part of at least one of a bag, container closure, septum and tube.

17. A chemical barrier lamination as defined in claim 1, comprising a first layer of PTFE, a second layer of ePTFE, and a third layer laminated between the second and third layers that is at least one of FEP, THV, PFA, PVDF and combinations or blends of one or more of the foregoing.

18. A chemical barrier lamination as defined in claim 17, wherein the first and second layers are skived and the third layer is a melt.

19. A chemical barrier lamination as defined in claim 1, wherein the first layer is ePTFE and the second layer is at least one of FEP, THV, PFA, PVDF and combinations or blends of one or more of the foregoing.

20. A chemical barrier lamination as defined in claim 19, forming at least one of a hose, wire or cable insulation, a bag and a tube.

21. A chemical barrier lamination as defined in claim 19, comprising a plurality of first layers and a plurality of second layers, wherein each first layer is laminated to at least one respective second layer.

22. A chemical barrier lamination as defined in claim 21, wherein the plural layers form a diaphragm.

23. A chemical barrier lamination as defined in claim 1, wherein the first layer is PTFE and the second layer is at least one of FEP, THV, PFA, PVDF and combinations or blends of one or more of the foregoing.

24. A chemical barrier lamination as defined in claim 23, wherein the first layer is skived and the second layer is non-skived.

25. A chemical barrier lamination as defined in claim 24, wherein the first layer defines a thickness within the range of about 1 mil to about 5 mils, and the second layer defines a thickness within the range of about ½ mil to about 4 mils.

26. A chemical barrier lamination as defined in claim 25, wherein the first layer defines a thickness within the range of about 3 mils to about 4 mils, and the second layer defines a thickness within the range of about ½ mil to about 2 mils.

27. A chemical barrier lamination as defined in claim 23, wherein the first layer is pigmented for color and the second layer is clear.

28. A chemical barrier lamination as defined in claim 1, wherein the first layer is at least one of FEP, THV and combinations or blends of the foregoing, and the second layer is at least one of polyethylene, PEN, nylon and combinations or blends of the foregoing.

29. A chemical barrier lamination as defined in claim 28, wherein the first layer is at least one of PTFE, PFA, FEP, THV, PVDF, and combinations or blends of the foregoing.

30. A chemical barrier lamination as defined in claim 29, wherein the first layer defines a thickness within the range of about ½ mil to about 5 mils, and the second layer defines a thickness within the range of about ½ mil to about 3 mils.

31. A chemical barrier lamination as defined in claim 30, wherein the first layer defines a thickness within the range of about 2 mils to about 3 mils, and the second layer defines a thickness within the range of about ½ mil to about 1 mil.

32. A chemical barrier lamination comprising:
first means formed of a substantially solid fluoropolymer and defining a thickness within the range of about ½ mil to about 4 mils for providing a chemically inert moisture vapor transmission barrier; and
second means laminated to the first means, formed of a substantially solid fluoropolymer, and defining a thickness within the range of about ½ mil to about 4 mils, for providing a chemically inert moisture vapor transmission barrier.

33. A chemical barrier lamination as defined in claim 32, wherein the first means is a first substantially solid fluoropolymer layer, and the second means is a second substantially solid fluoropolymer layer laminated to the first substantially solid fluoropolymer layer.

34. A chemical barrier lamination as defined in claim 33, wherein each substantially solid fluoropolymer layer is one of a skived fluoropolymer layer, a non-skived fluoropolymer layer, a melt extruded fluoropolymer layer, FEP, THV, PFA, PTFE, PVDF, ePTFE, and combinations or blends of one or more of the foregoing.

35. A chemical barrier lamination as defined in claim 32, further comprising third means laminated between the first and second means for substantially preventing the transmission of gas therebetween.

36. A chemical barrier lamination as defined in claim 35, wherein the third means is a polyethylene film.

37. A method comprising the following steps:
providing a first substantially solid fluoropolymer layer;
providing a second substantially solid fluoropolymer layer; and
laminating the first and second substantially solid fluoropolymer layers into a non-porous, chemically inert, moisture vapor transmission barrier lamination.

38. A method as defined in claim 37, wherein the laminating step includes applying at least one of heat and pressure to the first and second layers.

39. A method as defined in claim 37, wherein the laminating step further includes subjecting the lamination to a temperature within the range of about 600° F. to about 800° F.

40. A method as defined in claim 39, wherein the temperature is within the range of about 675° F. to about 725° F.

41. A method as defined in claim 37, further comprising modifying at least one of the first and second layers to enhance bondability during lamination.

42. A method as defined in claim 41, wherein the modifying step includes at least one of (i) chemically etching at least one of the first and second layers to facilitate bonding thereof during lamination, and (ii) at least one of plasma treating and corona treating at least one of the first and second layers to facilitate bonding thereof during lamination.

43. A method as defined in claim 37, wherein the laminating step includes at least one of (i) calendaring the first and second layers; and (ii) autoclaving the first and second layers.

44. A method as defined in claim 37, further comprising forming the film into at least part of at least one of a bag, septum, tube and container closure.

45. A method as defined in claim 37, further comprising laminating a polyethylene film between the first and second layers.

46. A method as defined in claim 37, wherein the providing step includes skiving a fluoropolymer into a skived film forming at least one of the first and second substantially solid fluoropolymer layers.

47. A method as defined in claim 37, wherein the providing step includes skiving first and second fluoropolymer films, and the laminating step includes laminating the first and second skived films directly to each other.

48. A method as defined in claim 47, wherein the providing step includes skiving at least one fluoropolymer film and providing at least one melt extruded fluoropolymer film, and the laminating step includes laminating the at least one skived fluoropolymer film to the at least one melt extruded fluoropolymer film.

49. A method as defined in claim 37, further comprising laminating at least one of a rubber and a thermoplastic layer to the first and second layers and forming at least one of a septum and a container closure.
